(19) United States
(12) Patent Application Publication
(10) Pub. No.: US 2026/0181556 A1
(43) Pub. Date: Jun. 25, 2026

(54) ELECTRONIC APPARATUS, POWER SUPPLY CONTROL METHOD, AND NON-TRANSITORY RECORDING MEDIUM

(71) Applicant: Norihiko SHUTOH, Tokyo (JP)

(72) Inventor: Norihiko SHUTOH, Tokyo (JP)

(73) Assignee: Ricoh Company, Ltd., Tokyo (JP)

(21) Appl. No.: 19/410,722

(22) Filed: Dec. 5, 2025

(30) Foreign Application Priority Data
Dec. 24, 2024 (JP) 2024-227060

(51) Int. Cl. H04W 52/02

(52) U.S. Cl. CPC H04W 52/0251

(57) ABSTRACT

An electronic apparatus includes circuitry that detects a use state of the electronic apparatus, detects a connection state of the electronic apparatus with a network, and performs power control on the electronic apparatus in accordance with the detected use state and the detected connection state.

### CROSS-REFERENCE TO RELATED APPLICATIONS

This patent application is based on and claims priority pursuant to 35 U.S.C. § 119(a) to Japanese Patent Application No. 2024-227060, filed on Dec. 24, 2024, in the Japan Patent Office, the entire disclosure of which is hereby incorporated by reference herein.

### BACKGROUND

### Technical Field

The present disclosure relates to an electronic apparatus, a power supply control method, and a non-transitory recording medium.

### Related Art

A technique related to power saving control for reducing power consumption by shifting to a power saving mode when a user is not using an apparatus has been proposed.

As a technique for reducing such power consumption, a configuration has been proposed in which power is turned off when a user interface (UI) device becomes inoperable and unrecoverable or when the connection with the UI device is disconnected for a long time.

### SUMMARY

The present disclosure described herein provides an electronic apparatus that includes circuitry that detects a use state of the electronic apparatus, detects a connection state of the electronic apparatus with a network, and performs power supply control on the electronic apparatus in accordance with the detected use state and the detected connection state.

The present disclosure described herein provides a power supply controlling method that includes detecting a use state of an electronic apparatus, detecting a connection state of the electronic apparatus with a network, and performing power control on the electronic apparatus in accordance with the detected use state and the detected connection state.

The present disclosure described herein provides a non-transitory recording medium storing a plurality of instructions which, when executed by one or more processors, causes the one or more processors to perform a power supply controlling method that includes detecting a use state of an electronic apparatus, detecting a connection state of the electronic apparatus with a network, and performing power control on the electronic apparatus in accordance with the detected use state and the detected connection state.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an external view of an image forming apparatus;

FIG. 2 is a block diagram illustrating a hardware configuration of an image forming apparatus;

FIG. 3 is a block diagram illustrating a functional configuration of an image forming apparatus;

FIG. 4 is a flowchart of controlling power supply performed by an image forming apparatus;

FIG. 5 is a flowchart of controlling power supply performed by an image forming apparatus; and

FIG. 6 is a flowchart of controlling power supply performed by an image forming apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Descriptions are given below of an electronic apparatus, a power supply control method, and a program for the power supply control method, with reference to the accompanying drawings. The present disclosure, however, is not limited to the following embodiments, and constituent elements of the following embodiments include elements conceivable by those skilled in the art, substantially the same elements, and elements within so-called equivalent ranges. Furthermore, various omissions, substitutions, changes, and combinations of the constituent elements may be made without departing from the gist of the following embodiments.

### External View of Image Forming Apparatus

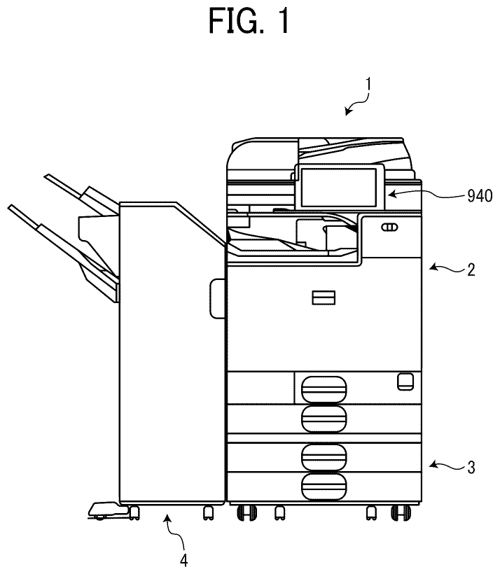

FIG. 1 is an external view of an image forming apparatus 1. A description is given of an overall configuration of the image forming apparatus 1 with reference to FIG. 1.

The image forming apparatus 1 illustrated in FIG. 1 is a multifunction peripheral (MFP) that has at least two functions of a copying function, a printing function, a scanning function, and a facsimile communication function. As illustrated in FIG. 1, the image forming apparatus 1 includes a main unit 2, a paper bank 3, a sheet ejection device 4, and an operation panel 940.

The image forming apparatus 1 is an example of an “electronic apparatus.” The “electronic apparatus” is not limited to the image forming apparatus 1, but may be an image forming apparatus other than the MFP such as a facsimile apparatus or an image reading apparatus, or an information processing device such as a personal computer (PC). In the following description, the image forming apparatus 1 is described as an example of an “electronic apparatus.”

The main unit 2 includes an image forming device that forms an image on a sheet fed from the paper bank 3 in accordance with a user operation on the operation panel 940. The main unit 2 includes a fixing device that fixes a color material onto a sheet on which an image has been formed, or includes a drying device that dries the sheet with a heat source.

The paper bank 3, which is optionally provided, includes trays on which sheets are loaded. The sheets are fed from the paper bank 3 to the main unit 2 in response to a command from the main unit 2.

The sheet ejection device 4, which is optionally provided, ejects the sheets on which the images are formed at the main unit 2 onto an ejection tray, in response to a command from the main unit 2.

The operation panel 940 includes an input device that receives an operation from a user and a display that displays various screens.

In the example illustrated in FIG. 1, the paper bank 3 and the sheet ejection device 4 are described as optional devices provided for the image forming apparatus 1. Alternatively, the image forming apparatus 1 may include another optional device such as an automatic reversing document feeder (ARDF) or a card reader.

### Hardware Configuration of Image Forming Apparatus

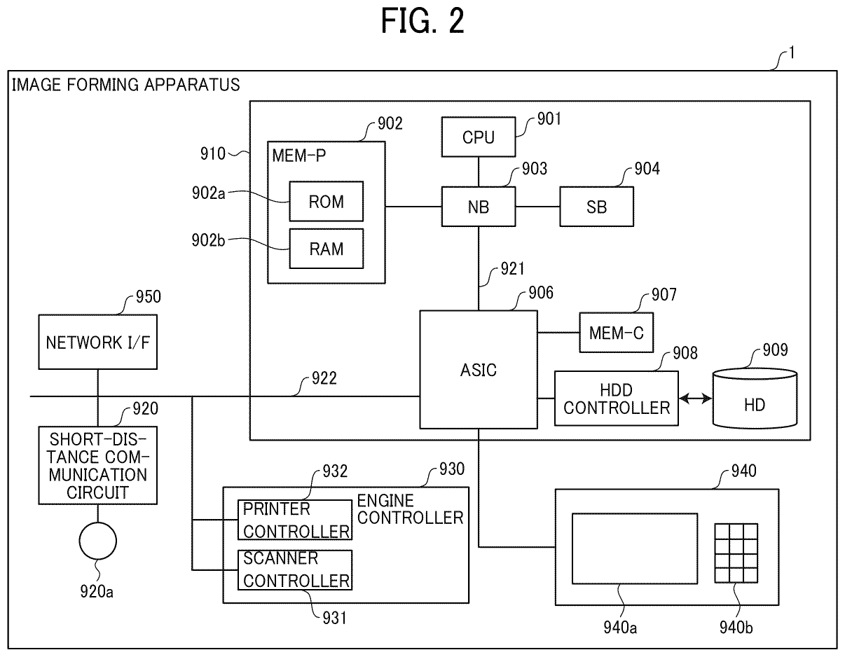

FIG. 2 is a block diagram illustrating a hardware configuration of the image forming apparatus 1. A description is given of the hardware configuration of the image forming apparatus 1 with reference to FIG. 2.

As illustrated in FIG. 2, the image forming apparatus 1 includes a controller 910, a short-distance communication circuit 920, an engine controller 930, the operation panel 940, and a network interface (I/F) 950.

The controller 910 includes a central processing unit (CPU) 901, a system memory (MEM-P) 902, a north bridge (NB) 903, a south bridge (SB) 904, an application-specific integrated circuit (ASIC) 906, a local memory (MEM-C) 907, a hard disk (HD) drive (HDD) controller 908, and an HD 909. The NB 903 and the ASIC 906 are connected by an accelerated graphics port (AGP) bus 921.

The CPU 901 is a processor that controls the overall operation of the image forming apparatus 1. The NB 903 is a bridge that connects the CPU 901 to the MEM-P 902, the SB 904, and the AGP bus 921. The NB 903 includes a memory controller that controls the reading of data from or the writing of data to the MEM-P 902, a peripheral component interconnect (PCI) master, and an AGP target.

The MEM-P 902 includes a read-only memory (ROM) 902a that stores programs and data for implementing various functions of the controller 910 and a RAM 902b used as a memory for deploying programs or data or for loading drawing data in printing. The programs stored in the RAM 902b may be stored, as a file installable or executable by the computer, in a computer-readable storage medium, such as a compact disc-read-only memory (CD-ROM), compact disc-recordable (CD-R), or digital versatile disc (DVD).

The SB 904 is a bridge that connects the NB 903 to, e.g., a PCI device or a peripheral device. The ASIC 906 is an Integrated Circuit (IC) dedicated to image processing, which has hardware elements for image processing, and connects the AGP bus 921, a PCI bus 922, the HDD controller 908, and the MEM-C 907 with one another. The ASIC 906 includes a PCI target, an AGP master, an arbiter (ARB) as a core element of the ASIC 906, a memory controller that controls the MEM-C 907, multiple Direct Memory Access Controllers (DMACs) that convert coordinates of image data with a hardware logic, and a PCI unit that transfers data between a scanner controller 931 and a printer controller 932 through the PCI bus 922. The ASIC 906 may be connected to a universal serial bus (USB) interface or an Institute of Electrical and Electronics Engineers 1394 (IEEE 1394) interface.

The MEM-C 907 is a local memory used as an image buffer for copying and a code buffer. The HD 909 is a storage for storing image files, font files used for printing, and forms. The HDD controller 908 is a controller that controls reading or writing of information from or to the CPU 901 under the control of the HD 909. The HDD controller 908 and the HD 909 may be a solid state drive (SSD).

The AGP bus 921 is a bus interface for a graphics accelerator card proposed to increase the speed of graphics processing, and can increase the speed of the graphics accelerator card by directly accessing the MEM-P 902 with high throughput.

The short-distance communication circuit 920 is a communication circuit such as near field communication (NFC) or Bluetooth®. The short-distance communication circuit 920 is electrically connected to the ASIC 906 via the PCI bus 922. The short-distance communication circuit 920 is provided with an antenna 920a for wireless communication.

The engine controller 930 includes the scanner controller 931 and the printer controller 932.

The operation panel 940 includes a panel display 940a such as a touch panel and a hard keypad 940b. The panel display 940a displays current settings or a selection screen to receive a user input. The hard keypad 940b includes a numeric keypad that receives set values of various image forming parameters such as an image density parameter and a start key that receives an instruction for starting copying.

In response to an instruction to select a specific application input using a mode switch key on the operation panel 940, the image forming apparatus 1 sequentially selects a document server function, a copy function, a print function, and a facsimile communication function. When the document server function is selected, the image forming apparatus 1 operates in a document server mode. When the copier function is selected, the image forming apparatus 1 operates in a copy mode. When the printer function is selected, the image forming apparatus 1 operates in a print mode. When the facsimile communication function is selected, the image forming apparatus 1 operates in a facsimile communication mode.

The network I/F 950 is an interface that controls communication of data through a network, in compliance with a communication protocol such as Ethernet® or Transmission Control Protocol (TCP)/Internet Protocol (IP). The network I/F 950 is electrically connected to the ASIC 906 through the PCI bus 922.

The hardware configuration of the image forming apparatus 1 is not limited to that illustrated in FIG. 2. The image forming apparatus 1 does not necessarily include all the components illustrated in FIG. 2 or may include some other components.

### Functional Configuration and Operation of Image Forming Apparatus

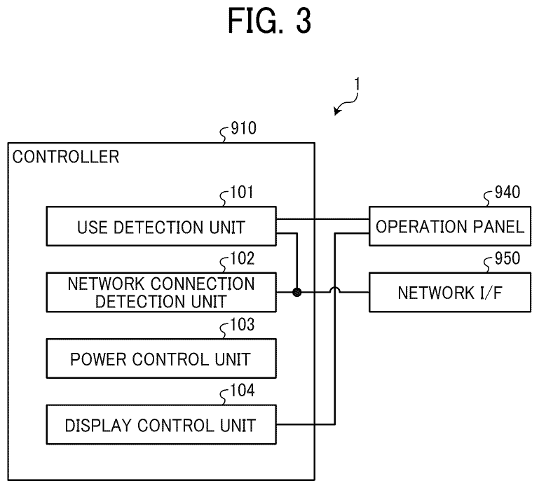

FIG. 3 is a block diagram illustrating a functional configuration of the image forming apparatus 1. A description is given of the functional configuration and operation of the image forming apparatus 1, with reference to FIG. 3.

As illustrated in FIG. 3, the controller 910 of the image forming apparatus 1 includes a use detection unit 101 (first detection unit), a network connection detection unit 102 (second detection unit), a power control unit 103, and a display control unit 104.

The use detection unit 101 is a functional unit that detects whether the image forming apparatus 1 is being used by the user. For example, the use detection unit 101 detects the use state of the image forming apparatus 1. The use of the image forming apparatus 1 is detected not only when an operation is performed on the operation panel 940 (the panel display 940a and the hard keypad 940b) of the image forming apparatus 1 but also when a function of the image forming apparatus 1 (e.g., image formation by a print job) is executed in response to an instruction that is received from an external device operated by the user via a network. In other words, the state in which the image forming apparatus 1 is not in use refers to a state in which no operation is performed on the operation panel 940 of the image forming apparatus 1 and no function of the image forming apparatus 1 is executed as no instruction is received from the external device via the network.

Examples of the network include, but not limited to, a local area network (LAN) or the Internet, through which the above-described network I/F 950 performs data communication compliant with TCP/IP, and a network through which data communication is performed with an external USB device via a USB interface. In the following, it is assumed that the network is a network through which the network I/F 950 performs the data communication.

The network connection detection unit 102 is a functional unit that detects whether the image forming apparatus 1 is connected to or disconnected from the network via the network I/F 950. In other words, the network connection detection unit 102 detects the connection state of the image forming apparatus 1 with the network.

The connection state refers to a state in which the network function of the network I/F 950 is enabled to allow data communication with an external device via the network. The term “disconnected” refers to a state including, e.g., a state in which the network I/F 950 is physically disconnected from the network, a state in which the network function of the network I/F 950 is disabled due to settings of the image forming apparatus 1, or a state in which data communication via the network I/F 950 is not possible due to a failure in the external device.

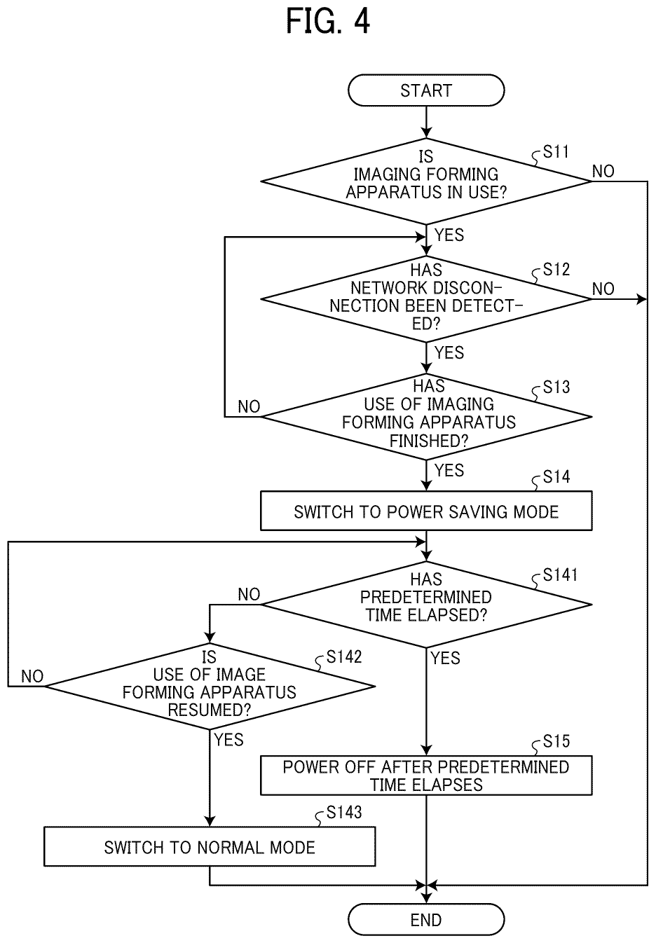

The power control unit 103 is a functional unit that performs power control on the image forming apparatus 1 in accordance with the state of the image forming apparatus 1. For example, the power control unit 103 performs power control on the image forming apparatus 1 in accordance with the state of the network that can be obtained via the network I/F 950. A description is given of control of the image forming apparatus 1 in accordance with the state of the network with reference to FIGS. 4 to 6 in detail. Specifically, the power control on the image forming apparatus 1 refers to control of switching the power mode of the image forming apparatus 1. Examples of the power modes include a normal mode in which the power in a certain amount is supplied, a power saving mode in which power smaller than the normal mode in amount is supplied to the image forming apparatus 1, and a power-off state in which the power of the image forming apparatus 1 is turned off. The power saving state refers to a state in which power consumption is reduced, e.g., by turning off the panel display 940a of the operation panel 940, placing the printer controller 932 in a sleep mode, and lowering the clock frequency of the CPU 901.

Even in the power saving state, the network function of the network I/F 950 remains active, such that jobs can be received.

Additionally, when the power mode is set to the normal mode, the power control unit 103 transitions the image forming apparatus 1 to the power saving mode, for example, in response to detection by the use detection unit 101 that the image forming apparatus 1 has been unused for a predetermined time.

The display control unit 104 is a functional unit that controls a display operation of the panel display 940a in the operation panel 940.

The use detection unit 101, the network connection detection unit 102, the power control unit 103, and the display control unit 104 are implemented by, for example, the CPU 901 of FIG. 2 that executes a program. Alternatively, at least a part of the use detection unit 101, the network connection detection unit 102, the power control unit 103, and the display control unit 104 may be implemented by a hardware circuit such as a field-programmable gate array (FPGA) or ASIC.

Each functional unit of the controller 910 illustrated in FIG. 3 is illustrated conceptually, and is not limited to such a configuration. In other words, each functional unit of the controller 910 does not necessarily have to be implemented as a distinct software module corresponding to the block illustrated in FIG. 3, and the functions of the respective functional units may be implemented as a whole by execution of a program by the CPU 901 of the controller 910. For example, the functional units illustrated as independent units in the controller 910 illustrated in FIG. 3 may be implemented as a single functional unit. In another example, the functions of a single functional unit in the controller 910 illustrated in FIG. 3 may be divided into a plurality of parts and implemented as a plurality of functional units. For example, when an additional CPU is provided for the operation panel 940, a part of the use detection unit 101, the network connection detection unit 102, the power control unit 103, and the display control unit 104 may be implemented by the additional CPU executing the program.

### Power Control in Image Forming Apparatus

*DEL* *DEL* *DEL* A description is given of operations of controlling power supply performed by the image forming apparatus 1 with reference to FIGS. 4 to 6.

First, as power control of the image forming apparatus 1, power control in a case where disconnection from the network is detected during use of the image forming apparatus 1 will be described with reference to FIG. 4.

### <Step S11>

In step S11, when the use detection unit 101 detects that the image forming apparatus 1 is in use (Yes in step S11), the process proceeds to step S12. When the use detection unit 101 detects that the image forming apparatus 1 is not in use (No in step S11), the process is terminated.

### <Step S12>

In step S12, when the network connection detection unit 102 detects that the network is disconnected (Yes in step S12), the process proceeds to step S13. When the network connection detection unit 102 detects that the network is connected (No in step S12), the process is terminated. The order of the determination of the step S11 and the step S12 may be reversed.

### <Step S13>

In step S13, when the use of the image forming apparatus 1 by the user has finished and the use detection unit 101 detects that the image forming apparatus 1 is not in use (Yes in step S13), the process proceeds to step S14. On the other hand, when the use detection unit 101 continuously detects that the image forming apparatus 1 is in use (No in step S13), the process returns to the step S12.

### <Step S14>

In step S14, the power control unit 103 switches the power mode of the image forming apparatus 1 to the power saving mode. The process proceeds to step S141. In step S141, when a predetermined time has elapsed after switching the power mode to the power saving mode (Yes in step S141), the process proceeds to step S15.

### <Step S15>

In step S15, the power control unit 103 turns off the power supply of the image forming apparatus 1 when a predetermined time has elapsed after switching the power mode to the power saving mode. In step S141, when a predetermined time has not elapsed after transition to the power saving mode (No in step S141), the process performs step S142. In step S142, the use detection unit 101 detects whether the use of the image forming apparatus 1 has been resumed. If the use detection unit 101 detects that the use of the image forming apparatus 1 is resumed (Yes in step S142), the process proceeds to step S143. On the other hand, when the use detection unit 101 detects that the use of the image forming apparatus 1 is not resumed (No in step S142), the process returns to the step S141. In step S143, the power control unit 103 switches the power mode back to the normal mode and the process is terminated.

With the above-described power control, when the network is in the disconnected state and the use of the image forming apparatus 1 has finished, the image forming apparatus 1 transitions to the power saving mode, thus reducing power consumption. Moreover, when the use of the image forming apparatus 1 is resumed by the user before a predetermined time has elapsed, the image forming apparatus 1 promptly returns to the normal mode, thus ensuring convenience. Further, when a predetermined time has elapsed after the transition to the power saving mode, the power supply of the image forming apparatus 1 is turned off, thus reducing power consumption.

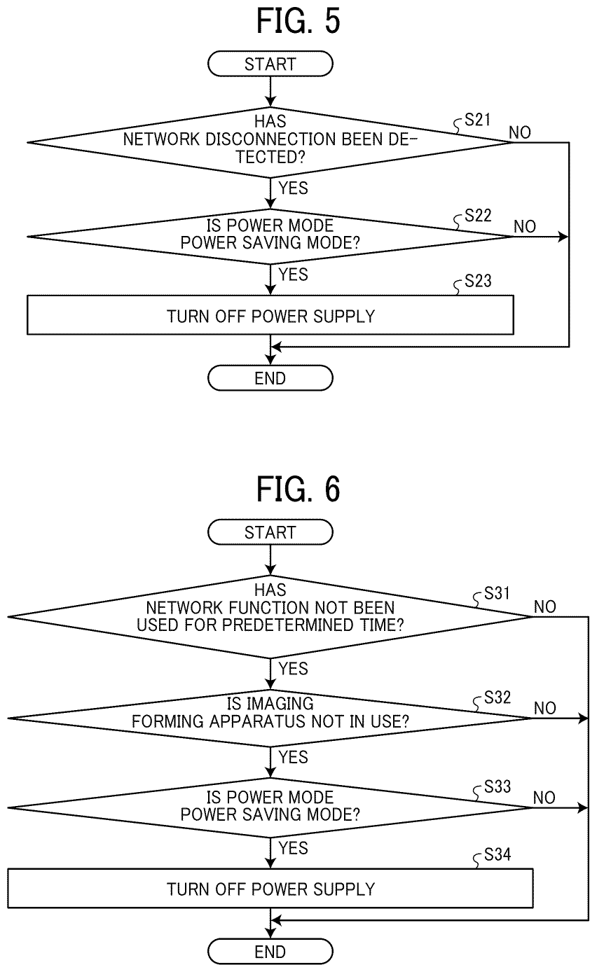

With reference to FIG. 5, a description is given below of power control of the image forming apparatus 1 when the network disconnection is detected while the image forming apparatus 1 is in the power saving mode.

### <Step S21>

In step S21, when the network connection detection unit 102 detects that the network is disconnected (Yes in step S21), the process proceeds to step S22. When the network connection detection unit 102 detects that the network is connected (No in step S21), the process is terminated.

### <Step S22>

In step S22, when the power mode of the image forming apparatus 1 is the power saving mode (Yes in step S22), the process proceeds to step S23. When the power mode of the image forming apparatus 1 is not the power saving mode (No in step S22), the process is terminated. The order of the determination of the step S21 and the step S22 may be reversed.

### <Step S23>

In step S23, the power control unit 103 turns off the power supply of the image forming apparatus 1.

With the above-described power control, when the network is in the disconnected state and the power mode is the power saving mode, the power supply of the image forming apparatus 1 is immediately turned off, thus further saving the power.

With reference to FIG. 6, a description is given below of the power control of the image forming apparatus 1 when the network function has not been used for a long period of time.

### <Step S31>

In step S31, when the network connection detection unit 102 detects that the network function has not been used for a predetermined time (Yes in step S31), the process proceeds to step S32. When the network connection detection unit 102 does not detect that the network function has not been used for the predetermined time (No in step S31), the process is terminated.

### <Step S32>

In step S32, when the use detection unit 101 detects that the image forming apparatus 1 is not in use (Yes in step S32), the process proceeds to step S33. When the use detection unit 101 detects that the image forming apparatus 1 is in use (No in step S32), the process is terminated.

### <Step S33>

In step S33, when the power mode of the image forming apparatus 1 is the power saving mode (Yes in step S33), the process proceeds to step S34. When the power mode is not the power saving mode (No in step S33), the process is terminated. The order of the determination of the step S32 and the step S33 may be reversed.

### <Step S34>

In step S34, the power control unit 103 turns off the power supply of the image forming apparatus 1.

With the power control as described above, even when the network is connected, as long as it is determined that the network function has not been used for a predetermined time, the image forming apparatus 1 is not in use, and the image forming apparatus is in the power saving mode, the power supply of the image forming apparatus 1 is immediately turned off, thus further saving the power.

The operations of steps S11 to S15 illustrated in FIG. 4, steps S21 to S23 illustrated in FIG. 5, and steps S31 to S34 illustrated in FIG. 6 are repeatedly executed, respectively, as long as the image forming apparatus 1 is not turned off.

In the related art, when a device is connected to a network, a minimum amount of power need to be maintained to enable control via the network, and thus the power supply to the device cannot be completely shut off, making it difficult to achieve further reduction in power consumption.

To further reduce power consumption, when the device is not in use by a user and is not connected to a network, it is conceivable to immediately shut off power supply to the device. With this method in the related art, because the power supply to the device is shut off immediately after the user finishes using the device, when the user subsequently intends to use the device again, a certain amount of time is required to turn the power supply back on, which leads to a reduction in user convenience.

According to the disclosure, the information processing apparatus can reduce the amount of power consumption appropriately.

As described above, in the image forming apparatus 1, the use detection unit 101 detects the use state of the image forming apparatus 1, the network connection detection unit 102 detects the connection state of the image forming apparatus 1 with the network, and the power control unit 103 performs power control on the image forming apparatus 1 in accordance with the use state detected by the use detection unit 101 and the connection state detected by the network connection detection unit 102. This reduces unnecessary power consumption without lowering the user convenience.

When at least one of the functional units of the controller 910 of the image forming apparatus 1 is implemented by execution of the program, the program may be pre-installed in, e.g., a ROM. Further, the program executed by the controller 910 of the image forming apparatus 1 may be recorded in a computer-readable recording medium, such as a compact disc read-only memory (CD-ROM), a flexible disk (FD), a compact disc-recordable (CD-R), or a digital versatile disc (DVD), in an installable or executable file format for distribution. Further, the program executed by the controller 910 of the image forming apparatus 1 may be stored on a computer connected to a network such as the Internet, to allow the program to be downloaded via the network. Further, the program executed by the controller 910 of the image forming apparatus 1 may be provided or distributed via a network such as the Internet. Further, the program executed by the controller 910 of the image forming apparatus 1 has a module configuration including at least one of the above-described functional units, and, in actual hardware, the CPU 901 reads the program from the above-described storage device and executes the program, such that each of the above-described functional units is loaded onto a main storage device for implementation.

Aspects of the present disclosure are as follows.

### Aspect 1

An electronic apparatus that includes a first detection unit that detects a use state of the electronic apparatus, a second detection unit that detects a connection state of the electronic apparatus with a network, and a power control unit that performs power control on the electronic apparatus in accordance with the use state detected by the first detection unit and the connection state detected by the second detection unit.

### Aspect 2

In the electronic apparatus according to Aspect 1, the power control unit switches a power mode of the electronic apparatus to a power saving mode and turns off power of the electronic apparatus after a predetermined time has elapsed, in a case where the first detection unit detects that the electronic apparatus is in use and the second detection unit detects that the network has been disconnected.

### Aspect 3

In the electronic apparatus according to Aspect 1 or 2, the power control unit turns off power of the electronic apparatus, in a case where the electronic apparatus is in the power saving mode when the second detection unit detects that the network is disconnected.

### Aspect 4

In the electronic apparatus according to any one of Aspects 1 to 3, the power control unit turns off power of the electronic apparatus, when the first detection unit detects that the electronic apparatus is not in use and the electronic apparatus is in the power saving mode in a case where the second detection unit detects that a network function of the electronic apparatus has not been used for a predetermined time.

### Aspect 5

In the electronic apparatus according to any one of Aspects 2 to 4, the power control unit shifts a power mode to the power saving mode when the first detection unit detects that the electronic apparatus has not been used for a predetermined time in a state where the power mode is a normal mode in which the electronic apparatus is in a normal power state.

### Aspect 6

The electronic apparatus according to any one of Aspects 1 to 5, the power control unit detects that the electronic apparatus is not in use, in a case where an operation unit of the electronic apparatus is not operated by a user and a function of the electronic apparatus is not executed via the network.

### Aspect 7

The electronic apparatus according to any one of Aspects 1 to 6, the second detection unit detects that the network is disconnected, when the electronic apparatus is physically disconnected from the network, when a network function is disabled by a setting of the electronic apparatus, or when data communication with an external device via the network is disabled.

### Aspect 8

A power supply controlling method includes a first detection step of detecting a use state of an electronic apparatus, a second detection step of detecting a connection state of the electronic apparatus with a network, and a power control step of performing power control on the electronic apparatus in accordance with the use state detected by the first detection step and the connection state detected by the second detection step.

### Aspect 9

A non-transitory recording medium storing a plurality of instructions which, when executed by one or more processors, causes the one or more processors to perform a power supply controlling method including detecting a use state of an electronic apparatus, detecting a connection state of the electronic apparatus with a network, and performing power control on the electronic apparatus in accordance with the detected use state and the detected connection state.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An electronic apparatus comprising circuitry configured to:
detect a use state of the electronic apparatus;
detect a connection state of the electronic apparatus with a network; and
perform power control on the electronic apparatus in accordance with the detected use state and the detected connection state.

2. The electronic apparatus according to claim 1,
wherein the circuitry is further configured to switch a power mode of the electronic apparatus to a power saving mode, and turn off power supply of the electronic apparatus after a predetermined time has elapsed, in a case where the detected use state indicates that the electronic apparatus is in use, and the detected connection state indicates that the network has been disconnected.

3. The electronic apparatus according to claim 1,
wherein the circuitry is further configured to turn off power supply of the electronic apparatus when the electronic apparatus is in a power saving mode, in a case where the detected connection state indicates that the network is disconnected.

4. The electronic apparatus according to claim 1,
wherein the circuitry is further configured to turn off power supply of the electronic apparatus when the electronic apparatus is in a power saving mode, in a case where the detected use state indicates that a network function of the electronic apparatus has not been used for a predetermined time and further indicates that the electronic apparatus is not in use.

5. The electronic apparatus according to claim 2,
wherein the circuitry is configured to detect that the network is disconnected when the electronic apparatus is physically disconnected from the network, when a network function is disabled by a setting of the electronic apparatus, or when data communication with an external device via the network is disabled.

6. The electronic apparatus according to claim 1,
wherein the circuitry is further configured to switch a power mode of the electronic apparatus to a power saving mode, when the electronic apparatus is in a normal mode in which power is supplied in an amount greater than an amount of power in the power saving mode, and when it is detected that a predetermined time has elapsed in a case where the detected use state indicates that the electronic apparatus is not in use.

7. The electronic apparatus according to claim 1,
wherein the circuitry is configured to detect the connection state indicating that the network is disconnected, when the electronic apparatus is physically disconnected from the network, when a network function is disabled by a setting of the electronic apparatus, or when data communication with an external device via the network is disabled.

8. The electronic apparatus according to claim 1,
wherein the circuitry is further configured to
switch a power mode of the electronic apparatus to a power saving mode, in a case where the detected use state indicates that the electronic apparatus is in use and the detected connection state indicates that the network has been disconnected, and
switch the power mode to a normal mode, in a case where the detected use state indicates that the use of the electronic apparatus is resumed before a predetermined time has elapsed after switching the power mode of the electronic apparatus to the power saving mode.

9. A power supply controlling method comprising:
detecting a use state of an electronic apparatus,
detecting a connection state of the electronic apparatus with a network, and
performing power control on the electronic apparatus in accordance with the detected use state and the detected connection state.

10. A non-transitory recording medium storing a plurality of instructions which, when executed by one or more processors, causes the one or more processors to perform a power supply controlling method comprising:
detecting a use state of an electronic apparatus,
detecting a connection state of the electronic apparatus with a network, and
performing power control on the electronic apparatus in accordance with the detected use state and the detected connection state.
